(19) United States
(12) Patent Application Publication
(10) Pub. No.: US 2015/0275844 A1
(43) Pub. Date: Oct. 1, 2015

(54) HYDRAULIC TURBINE SYSTEM WITH AUXILIARY NOZZLES

(71) Applicant: Energy Recovery, Inc., San Leandro, CA (US)

(72) Inventors: Felix Winkler, San Leandro, CA (US); Ying Ma, Castro Valley, CA (US); Prem Krish, Foster City, CA (US)

(21) Appl. No.: 14/670,231

(22) Filed: Mar. 26, 2015

Related U.S. Application Data
(60) Provisional application No. 61/970,769, filed on Mar. 26, 2014.

(51) Int. Cl. F03B 1/02; F03B 11/00

(52) U.S. Cl. CPC F03B 1/02; F03B 11/004

(57) ABSTRACT

A system including a hydraulic turbine system, including a first hydraulic turbine, including a first hydraulic body with a first runner chamber, a first runner within the first runner chamber, a first primary nozzle fluidly coupled to the first runner chamber, a first auxiliary nozzle fluidly coupled to the first runner chamber and configured to equalize pressure in the first runner chamber, and a first valve fluidly coupled to the first auxiliary nozzle and configured to control a fluid flow into the first runner chamber.

### CROSS-REFERENCE TO RELATED APPLICATION

This application claims priority to and benefit of U.S. Provisional Patent Application No. 61/970,769, entitled “HYDRAULIC TURBINE SYSTEM WITH AUXILIARY NOZZLES,” filed on Mar. 26, 2014, which is hereby incorporated by reference in its entirety for all purposes.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The subject matter disclosed herein relates to hydraulic turbines. Hydraulic turbines generate work using fluid to rotate a runner. As the runner rotates, the runner rotates a shaft coupled to equipment. Unfortunately, the hydraulic turbine may expose the runner to pressure imbalances that form radial thrust on the runner. Over time, the radial thrust may wear hydraulic turbine components.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a cross-sectional view of an embodiment of a hydraulic turbine system;

FIG. 2 is a cross-sectional view of an embodiment of a pressure-compensated-flow-control valve;

FIG. 3 is a cross-sectional view of an embodiment of a pressure-compensated-flow-control valve;

FIG. 4 is a schematic diagram of an embodiment of a hydraulic turbine system with a first hydraulic turbine in series with a second hydraulic turbine and a valve that controls the flow of fluid through auxiliary nozzles on the first and second hydraulic turbines; and

FIG. 5 is a schematic diagram of an embodiment of a hydraulic turbine system with a first hydraulic turbine in series with a second hydraulic turbine and a valve that controls the flow of fluid through auxiliary nozzles on the first and second hydraulic turbines.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Hydraulic turbine systems generate work that powers various pieces of equipment including electrical generators, pumps, compressors, and other industrial equipment. In operation, fluid flows through a primary nozzle in a hydraulic turbine that rotates a runner coupled to a shaft. Unfortunately, the fluid flow from the primary nozzle may form pressure imbalances within the hydraulic turbine that create radial thrust (i.e., radial force) on the runner. The embodiments below disclose hydraulic turbine systems with one or more auxiliary nozzles that facilitate pressure equalization within the hydraulic turbine. By equalizing the pressure around the runner, the hydraulic turbine system reduces or blocks radial thrust on the runner, thereby reducing wear on hydraulic turbine system components. Moreover, by including one or more auxiliary nozzles, the hydraulic turbine system can change the flow of fluid through the hydraulic turbine and thus the amount of work performed. In order to control the flow of fluid through the hydraulic turbine, the hydraulic turbine system may include valves, such as an autonomous pressure-compensated-flow-control valve. For example, a hydraulic turbine system may fluidly couple a pressure-compensated-flow-control valve to an auxiliary nozzle to maintain constant or substantially constant flow through the auxiliary nozzle. In certain embodiments, the hydraulic turbine system may include a single valve capable of simultaneously controlling fluid flow through multiple auxiliary nozzles on an individual hydraulic turbine and/or auxiliary nozzles on multiple hydraulic turbines.

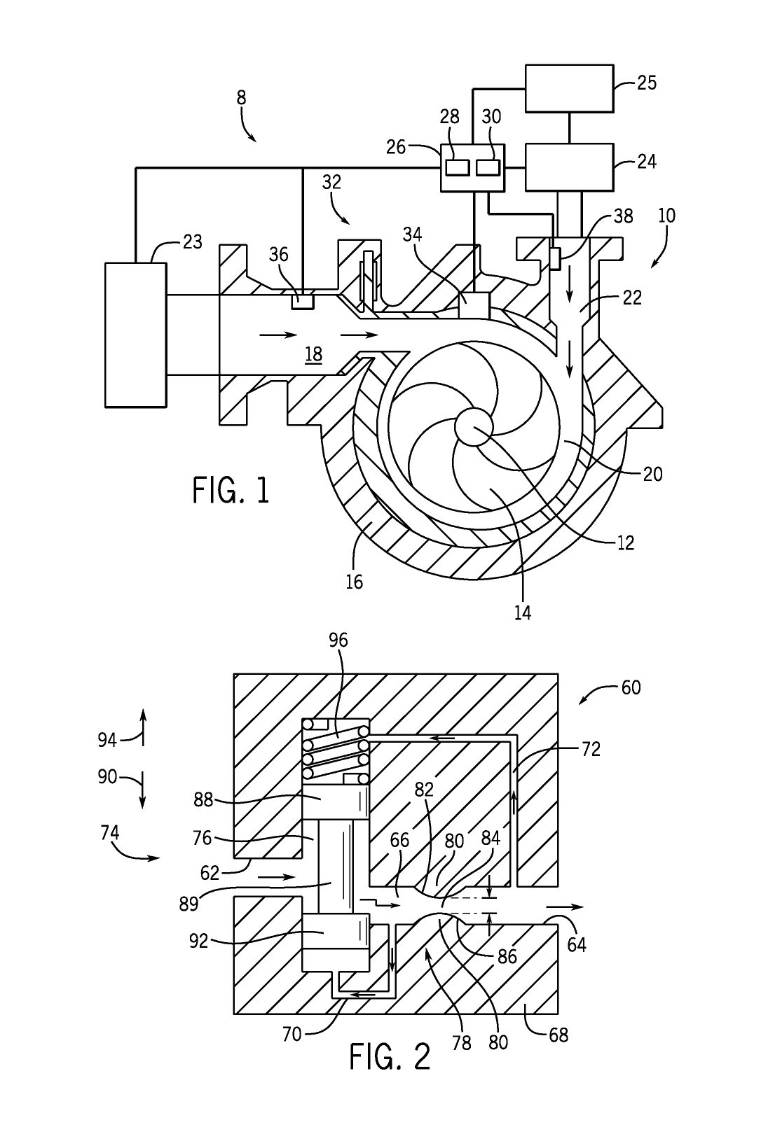

FIG. 1 is a cross-sectional view of an embodiment of a hydraulic turbine system 8 with a hydraulic turbine 10 (e.g., reaction type hydraulic turbines) that converts fluid flow into mechanical work by spinning a shaft 12 coupled to a runner 14 (e.g., rotor with blades). For example, rotation of the shaft 12 produces mechanical work that can power various pieces of equipment including electrical generators, pumps, compressors, and other industrial equipment. In operation, fluid enters a hydraulic turbine body 16 through a primary nozzle 18 that directs the fluid flow into a runner chamber 20 (e.g., volute scroll), where the fluid contacts and rotates the runner 14. In order to control fluid flow (e.g., increase fluid turndown control) into the hydraulic turbine system 8, the hydraulic turbine system may include auxiliary/secondary nozzles 22. Indeed, the hydraulic turbine system 8 can use these auxiliary/secondary nozzles 22 to increase or decrease the amount of fluid flowing through the hydraulic turbine system 8 as well as control a pressure distribution within the runner chamber 20. By controlling the pressure distribution, the hydraulic turbine system 8 can reduce uneven pressure distribution in the runner chamber 20, and thus reduce radial thrust (i.e., radial force) on the runner 14.

The hydraulic turbine system 8 may include 1 to 100, 2 to 75, 3 to 50, 4 to 25, 5 to 10, or more auxiliary/secondary fluid nozzles 22 that facilitate control of fluid flow through the hydraulic turbine system 8. These auxiliary nozzles 22 may be uniformly or non-uniformly spaced, shaped, angled, and/or sized (e.g., inlet areas or diameters). In some embodiments, the hydraulic turbine system 8 includes one or more auxiliary/secondary nozzles 22 that enter the runner chamber 20 in a tangential orientation or near tangential orientation. The auxiliary/secondary nozzles 22 may also be offset from the primary nozzle 18 about the circumference of the hydraulic turbine body 16 (e.g., 5, 10, 15, 30, 45, 60, 75, 90, 120, 150, 180, 210, 240, 270, 300, 330, etc. degrees). Moreover, the inlet area of these auxiliary nozzles 22 may be smaller than that of the primary nozzle 18.

To control fluid flow through the hydraulic turbine system 8, the hydraulic turbine system 8 may include valves 23, 24 (e.g., pressure-compensated-flow-control valve, butterfly valves, globe valves, needle valves, plug valves, gate valves) that couple to the respective primary and auxiliary nozzles 18, 22. In embodiments with multiple auxiliary nozzles 22, the hydraulic turbine system 8 may include a valve 24 for each auxiliary nozzle 22. In some embodiments, each auxiliary/secondary nozzle 22 may fluidly couple to a respective pressure-compensated-flow-control valve that maintains constant fluid flow. In certain embodiments, the hydraulic turbine system 8 may also include a throttle valve 25 upstream of the auxiliary nozzle valves 24 (e.g., pressure-compensated-flow-control valves) that may be used to change the total flow through the hydraulic turbine 10 (e.g., fluid turndown control).

The valves 23, 24 may operate autonomously or with input from a controller 26. For example, the hydraulic turbine system 8 may include the controller 26 with a processor 28 and a memory 30. In operation, the controller 26 may communicate with one or more sensors 32 (e.g., flow rate sensors, pressure sensors, velocity sensors, etc.) to control fluid flow through the primary and/or auxiliary nozzles 18, 22. For example, the hydraulic turbine system 8 may include a sensor 34 within the runner chamber 20, a sensor 36 in the primary nozzle 18, and/or a sensor 38 within the auxiliary nozzle 22. In operation, the controller 26 receives feedback from one or more of these sensors 32. As the controller 26 receives feedback, the processor 28 executes instructions stored in the memory 30 to open, close, partially open, or partially close the valves 23, 24 to effectively change the flow rate through the hydraulic turbine system 8 (i.e., change the backpressure of the hydraulic turbine system 8). As the flow rate changes through the hydraulic turbine system 8, the hydraulic turbine system 8 is able to control the work done by the shaft 12 as well as the pressure distribution in the runner chamber 20. As explained above, the hydraulic turbine system 8 reduces radial thrust on the runner 20 by equalizing the pressure distribution in the runner chamber 20, thereby reducing wear on the runner 20 and components (e.g., bearings) within the hydraulic turbine system 8.

FIG. 2 is a cross-sectional view of an embodiment of a pressure-compensated-flow-control valve 60. In operation, the pressure-compensated-flow-control valve 60 operates autonomously (i.e., without controller input) to maintain a constant flow or substantially constant rate through the auxiliary nozzle 22. As will be explained below, the pressure-compensated-flow-control valve 60 is able to maintain constant flow or near constant flow (e.g., a flow rate within a range of 1, 2, 3, 4, 5, 6, 7, 8, 9, 10% of the desired flow rate) to the auxiliary nozzle 22 regardless of changing pressure conditions upstream and downstream of the pressure-compensated-flow-control valve 60. As illustrated, the pressure-compensated-flow-control valve 60 includes an inlet 62 that couples to a fluid source, and an outlet 64 that couples to the auxiliary nozzle 22. Between the inlet 62 and the outlet 64 is a fluid pathway 66 that guides fluid through the valve body 68. Fluidly coupled to the fluid pathway 66 are upstream- and downstream-pressure sensing pathways 70, 72. In operation, the upstream and downstream pressure sensing pathways 70, 72 drive a double piston 74 within a piston chamber 76 in response to pressure changes in the fluid pathway 66, to maintain a constant flow rate.

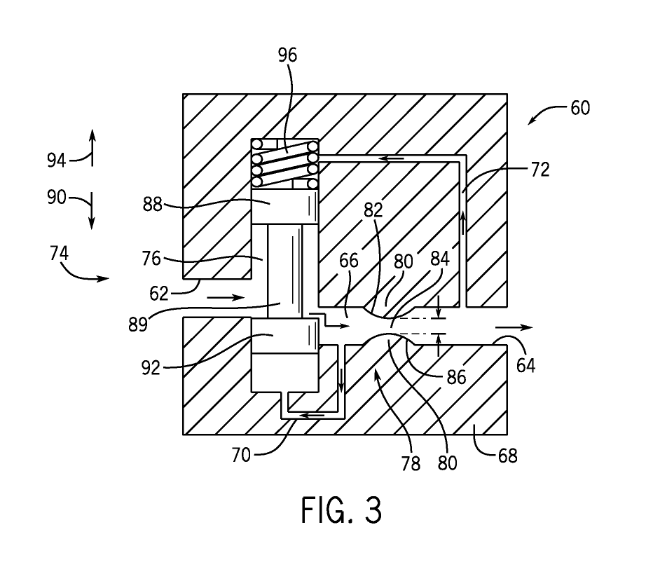

In order to adjust for pressure changes both upstream and downstream of the pressure-compensated-flow-control valve 60, the pressure-compensated-flow-control valve 60 includes a restriction orifice 78 (e.g., venturi section) in the fluid pathway 66. The restriction orifice 78 is formed by protrusions 80 that reduce the area of the fluid pathway 66. In some embodiments, the restriction orifice 78 may include a converging section 82 that leads to a throat 84 and a diverging section 86 downstream of the throat 84. The reduction in area of the fluid pathway 66 forms a pressure drop across the restriction orifice 78 that separates the pressures sensed by the upstream and downstream pressure sensing pathways 70, 72. In other words, the restriction orifice 78 enables the upstream sensing pathway 70 to respond to pressure upstream of the restriction orifice 78 and the downstream sensing pathway 72 to respond to pressure downstream of the restriction orifice 78. For example, as pressure increases downstream of the restriction orifice 78, the downstream-pressure-sensing pathway 72 diverts fluid flow from the fluid pathway 66 to the piston chamber 76. As fluid enters the piston chamber 76, the fluid drives a first piston 88 and a rod 89 in axial direction 90 increasing the flow of fluid in the fluid pathway 66 Likewise, as pressure increases upstream of the restriction orifice 80, the upstream-pressure-sensing pathway 70 diverts fluid to the piston chamber 76 (see FIG. 3). As fluid enters the piston chamber 76, the fluid drives the second piston 92 and the rod 89 in axial direction 94, compressing a spring 96 which closes or partially closes the fluid pathway 66 to reduce fluid flow through the pressure-compensated-flow-control valve 60 (see FIG. 3). In this manner, the fluid flow through each pressure-compensated-flow-control valve 60 remains the same regardless of upstream and downstream pressure changes. As explained above, the hydraulic turbine system 8 may include a throttle valve upstream of the pressure-compensated-flow-control valves 60 that changes overall flow through the pressure-compensated-flow-control valve 60.

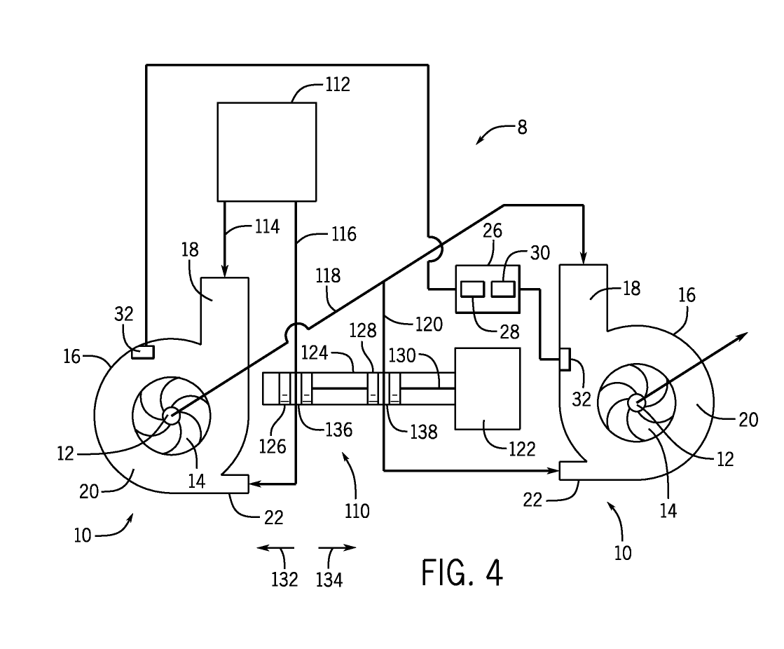

FIG. 4 is a schematic diagram of a hydraulic turbine system 8 with a first hydraulic turbine 10 in series with a second hydraulic turbine 10 and a valve 110 that controls the flow of fluid through auxiliary nozzles 22. In some embodiments, the valve 110 may control fluid flow to multiple auxiliary nozzles 22 on a standalone hydraulic turbine 10 and/or two or more hydraulic turbines 10 coupled together (e.g., multiple turbine stages in a common housing using a single shaft 12 or multiple hydraulic turbines 10 that drive separate shafts 12). For example, the hydraulic turbine system 8 may include 2, 3, 4, 5, 6, 7, 8, 9, 10, or more hydraulic turbines that couple together in series.

As illustrated in FIG. 4, the hydraulic turbine system 8 may include two hydraulic turbines 10 fluidly coupled in a manner that cascadingly converts fluid flow into mechanical work. As illustrated, the first hydraulic turbine system 10 fluidly couples to the second hydraulic turbine system 10. In operation, a fluid source 112 provides a fluid that enters the first primary nozzle 18 through the first fluid line 114. As the fluid enters the hydraulic turbine 10, the fluid imparts torque on the first runner 14 to produce mechanical work. As explained above, the first hydraulic turbine 10 may include one or more auxiliary nozzles (e.g., 1, 2, 3, 4, 5, or more) that provide fluid flow that equalizes pressure on the first runner 14 to reduce radial thrust (i.e., radial force) and/or changes fluid flow through the first hydraulic turbine 10 (e.g., increase fluid flow). The fluid flow to the auxiliary nozzle 22 may come from a second fluid line 116. As the fluid in the second fluid line 116 enters the first hydraulic turbine 10, the fluid increases fluid flow through the first hydraulic turbine 10 and/or equalizes pressure on the runner 14. After exiting the first hydraulic turbine 10, the fluid enters the third fluid line 118 and becomes the fluid source for the second hydraulic turbine 10. As illustrated, the fluid flowing through the third fluid line 118 enters the primary nozzle 18 of the second hydraulic turbine 10, where the fluid imparts torque on the second runner 14. However, a portion of the fluid in the third fluid line 118 may enter a fourth fluid line 120 that couples to at least one or more auxiliary nozzles 22 (e.g., 1, 2, 3, 4, 5, or more) on the second hydraulic turbine 10.

In order to control the fluid flow through the auxiliary nozzles 22, the hydraulic turbine system 8 includes the valve 110. As illustrated, the valve 110 includes an actuator 122 that couples to a valve housing 124. In operation, the actuator 122 moves gates 126, 128 simultaneously by driving a connector 130 (e.g., one or more rods) in axial directions 132, 134. As the actuator 122 (e.g., electric motor, manual actuator) axially drives the gates 126, 128, the gates 126 and 128 control the flow of fluid through the valve 110 by opening, closing, partially opening, or partially closing the respective openings 136, 138 (e.g., orifices). In some embodiments, the openings 136 and 138 may have variable orifices that change in size or shape in axial directions 132 and 134. In this manner, one actuator 122 may increase and decrease fluid flow through auxiliary nozzles 22 as well as equalize pressure in one or more hydraulic turbines 10, which reduces the complexity and cost of controlling fluid flow in multiple systems. In certain embodiments, the valve 110 may have a single gate with the two openings 136, 138.

In some embodiments, the hydraulic turbine system 8 may include a controller 26 that couples to the actuator 122. The controller 26 may include the processor 28 and the memory 30. In operation, the controller 26 may communicate with one or more sensors 32 (e.g., flow rate sensors, pressure sensors, velocity sensors, etc.) to control fluid flow through the auxiliary nozzles 22. As the controller 26 receives feedback from the sensors 32, the processor 28 executes instructions stored in the memory 30 to move the gates 126, 128 in axial directions 132, 134. As the actuator 122 moves in axial direction 132, 134 the actuator 110 opens, closes, partially opens, or partially closes the valve 110 to effectively change the flow rate through the hydraulic turbine system 8 (i.e., change the backpressure of the hydraulic turbine system 8). As explained above, the hydraulic turbine system 8 reduces radial thrust on the runner 20 by equalizing the pressure distribution in the runner chamber 20, thereby reducing wear on the runner 20 and components (e.g., bearings) within the hydraulic turbine system 8.

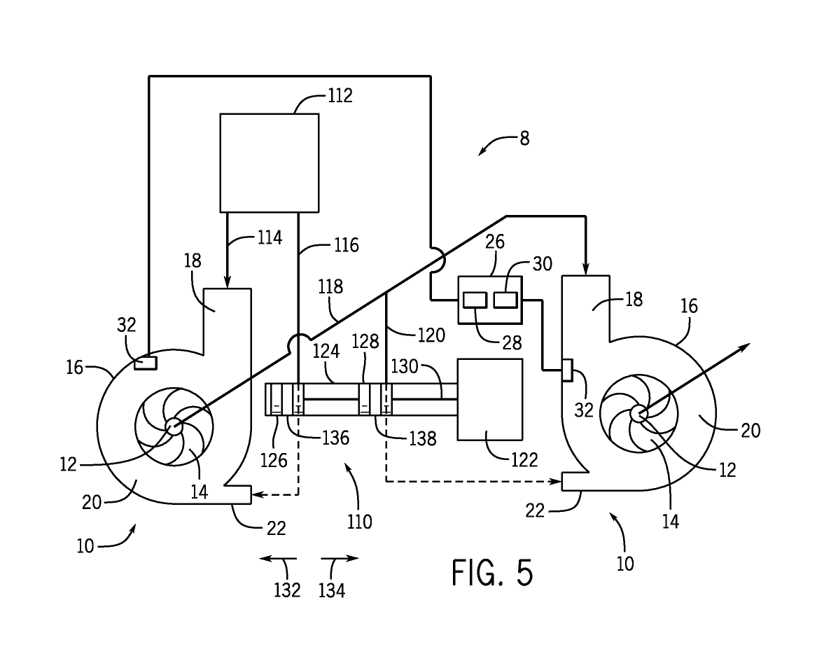

FIG. 5 is a schematic diagram of a hydraulic turbine system 8 with the valve 110 in a closed position. As explained above, the actuator 122 moves the gates 126, 128 axially to change the amount of fluid flowing through the second line 116 and the fourth line 120. For example, the actuator 122 may move the gates 126, 128 in axial direction 132 to misalign the openings 136, 138 with the respective second fluid line 116 and the fourth fluid line 120. In this manner, the actuator 122 may close the valve 110 blocking fluid flow to the auxiliary nozzles 22.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalvents, and alternatives falling within the spirit and scope of the invention as defined by the following appended claims.

1. A system, comprising:
a hydraulic turbine system, comprising:
a first hydraulic turbine, comprising:
a first hydraulic body with a first runner chamber;
a first runner within the first runner chamber;
a first primary nozzle fluidly coupled to the first runner chamber;
a first auxiliary nozzle fluidly coupled to the first runner chamber and configured to equalize pressure in the first runner chamber; and
a first valve fluidly coupled to the first auxiliary nozzle and configured to control a fluid flow into the first runner chamber.

2. The system of claim 1, comprising a second hydraulic turbine fluidly coupled to the first hydraulic turbine, wherein the second hydraulic turbine comprises a second primary nozzle and a second auxiliary nozzle.

3. The system of claim 2, wherein the first valve is configured to simultaneously control the fluid flow through the first auxiliary nozzle and the second auxiliary nozzle.

4. The system of claim 3, wherein the first valve comprises a gate with a first opening and a second opening, the first opening controls fluid flow to the first auxiliary nozzle, and the second opening controls fluid flow to the second auxiliary nozzle.

5. The system of claim 1, wherein the first valve comprises a pressure-compensated-flow-control valve configured to deliver a substantially constant flow rate to the first auxiliary nozzle.

6. The system of claim 5, wherein the pressure-compensated-flow-control valve comprises a piston in a piston chamber.

7. The system of claim 6, wherein the piston is configured to move axially to cover and uncover a fluid passage through the pressure-compensated-flow-control valve.

8. The system of claim 6, wherein the pressure-compensated-flow-control valve comprises a restriction orifice in the fluid passage.

9. The system of claim 8, wherein the pressure-compensated-flow-control valve comprises an upstream-pressure-sensing passage and a downstream-pressure-sensing passage.

10. The system of claim 6, comprising a spring configured to drive the piston axially to uncover a fluid passage.

11. The system of claim 1, comprising a second valve fluidly coupled to the first valve, wherein the second valve is configured to increase and decrease the fluid flow through the auxiliary nozzle.

12. The system of claim 1, comprising a controller configured to control the first valve to control the fluid flow through the first auxiliary nozzle.

13. A system, comprising:
a hydraulic turbine system, comprising:
a hydraulic turbine, comprising:
a hydraulic body with a runner chamber;
a runner within the runner chamber;
a primary nozzle fluidly coupled to the runner chamber;
an auxiliary nozzle fluidly coupled to the runner chamber and configured to equalize pressure in the runner chamber; and
a pressure-compensated-flow-control valve fluidly coupled to the auxiliary nozzle and configured to control a fluid flow into the runner chamber.

14. The system of claim 13, wherein the pressure-compensated-flow-control valve comprises a piston in a piston chamber, and the piston is configured to move axially to cover and uncover a fluid passage through the pressure-compensated-flow-control valve.

15. The system of claim 14, wherein the pressure-compensated-flow-control valve comprises a restriction orifice in the fluid passage.

16. The system of claim 13, wherein the pressure-compensated-flow-control valve comprises an upstream-pressure-sensing passage and a downstream-pressure-sensing passage.

17. The system of claim 14, comprising a spring configured to drive the piston axially to uncover the fluid passage.

18. A system, comprising:
a hydraulic turbine system, comprising:
a first hydraulic turbine, comprising:
a first hydraulic body with a first runner chamber;
a first runner within the first runner chamber;
a first primary nozzle fluidly coupled to the first runner chamber;
a first auxiliary nozzle fluidly coupled to the first runner chamber and configured to equalize pressure in the first runner chamber; and
a second hydraulic turbine, comprising:
a second hydraulic body with a second runner chamber;
a second runner within the second runner chamber;
a second primary nozzle fluidly coupled to the second runner chamber; and
a second auxiliary nozzle fluidly coupled to the second runner chamber and configured to equalize pressure in the second runner chamber; and
a valve fluidly coupled to the first auxiliary nozzle and the second auxiliary nozzle and configured to simultaneously control a fluid flow into the first runner chamber and the second runner chamber.

19. The system of claim 18, wherein the valve comprises a gate with a first opening and a second opening, the first opening controls fluid flow to the first auxiliary nozzle, and the second opening controls fluid flow to the second auxiliary nozzle.

20. The system of claim 19, comprising an actuator coupled to gate.
